(19) United States
(12) Patent Application Publication
(10) Pub. No.: US 2007/0228964 A1
(43) Pub. Date: Oct. 4, 2007

(54) Plasma display panel (PDP)

(76) Inventors: Kyoung-Doo Kang, Suwon-si (KR); Won-Ju Yi, Suwon-si (KR); Ho-Young Ahn, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/726,415

(22) Filed: Mar. 22, 2007

(30) Foreign Application Priority Data
Mar. 31, 2006 (KR) 10-2006-0029722

(51) Int. Cl. H01J 17/49

(52) U.S. Cl. 313/582; 313/586; 313/585

(57) ABSTRACT

Provided is a plasma display panel (PDP) having a structure that prevents a frit from penetrating into a display area during a process of sealing the PDP. The PDP includes: a pair of substrates spaced apart from each other and facing each other; a sheet interposed between the pair of substrates and comprising a barrier rib part, defining discharge cells, and a dielectric part disposed on edges of the barrier rib part; first discharge electrodes disposed in the sheet; second discharge electrodes disposed in the sheet and spaced apart from the first discharge electrodes; a frit disposed between the pair of substrates and the dielectric part and sealing the pair of substrates; a groove formed on at least one of the pair of substrates and where at least a part of the frit is disposed; phosphor layers arranged in the discharge cells; and a discharge gas sealed in the discharge cells.

### CROSS-REFERENCE TO RELATED PATENT APPLICATION

This application claims the benefits of Korean Patent Application No. 10-2006-0029722, filed on Mar. 31, 2006, in the Korean Intellectual Property Office, the disclosure which is incorporated herein in its entirety by reference.

### BACKGROUND OF THE INVENTION

1. Field of the Invention

The present embodiments relate to a plasma display panel (PDP) and, more particularly, to a PDP that prevents a display area from being contaminated due to a frit.

2. Description of the Related Art

Plasma display panels (PDPs) which have largely replaced conventional cathode (CRT) display devices display desired images using visible rays generated by sealing discharge gas and applying a discharge voltage between two substrates on which a plurality of electrodes are formed to generate vacuum ultraviolet rays, and exciting phosphors on which the vacuum ultraviolet rays are formed in a predetermined pattern.

PDPs include discharge electrodes and barrier ribs between two substrates, from discharge cells, adhere a frit having a predetermined thickness inside edges of the two substrates, seal the two substrates, and charge a discharge gas.

FIG. 1 is a plan view of a conventional plasma display panel 1 on which a frit 3 is adhered. Referring to FIG. 1, the frit 3 is disposed in edges of two substrates 2 of the plasma display panel 1, and a display area 4 that displays an image is disposed inside the edges.

When the two substrates 2 are heated and pressurized during a sealing process, the frit 3 melts, spreads in all directions, and is baked, thereby sealing the plasma display panel 1.

However, since the melted frit 3 penetrates into the display area 4 that displays the image, discharge cells are contaminated and spots are generated when the plasma display panel 1 displays the image, deteriorating quality of the image.

### SUMMARY OF THE INVENTION

The present embodiments provide a plasma display panel (PDP) having a structure that prevents a frit from penetrating into a display area during a process of sealing the PDP.

According to an aspect of the present embodiments, there is provided a plasma display panel (PDP) comprising: a pair of substrates spaced apart from each other and facing each other; a sheet interposed between the pair of substrates, the sheet comprising a barrier rib part defining discharge cells and a dielectric part disposed on edges of the barrier rib part; first discharge electrodes disposed in the sheet; second discharge electrodes disposed in the sheet and spaced apart from the first discharge electrodes; a frit disposed between the pair of substrates and the dielectric part and sealing the pair of substrates; a groove formed on at least one of the pair of substrates and where at least a part of the frit is disposed; phosphor layers arranged in the discharge cells; and a discharge gas sealed in the discharge cells.

The first discharge electrodes and the second discharge electrodes may surround at least a portion of each of the discharge cells.

The first discharge electrodes may extend in a direction and the second discharge electrodes cross the first discharge electrodes.

The PDP may further comprise; third discharge electrodes crossing the first discharge electrodes and the second discharge electrodes, the first discharge electrodes and the second discharge electrodes extending in a direction.

The third discharge electrodes may be disposed in the sheet and spaced apart from the first discharge electrodes and the second discharge electrodes.

The third discharge electrodes may surround at least a portion of each of the discharge cells.

The grooves may be stripe-shaped.

The grooves may be spaced apart from each other and discontinuously arranged.

When the grooves are formed in each of the pair of substrates, the grooves may face the sheet and oppose each other.

The frit may be disposed inside the grooves.

According to an aspect of the present embodiments, there is provided a PDP comprising: a pair of substrates spaced apart from each other and facing each other; a barrier rib interposed between the pair of substrates and, and defining discharge cells; a dielectric wall formed on at least one of the pair of substrates and disposed on edges of the barrier rib; first discharge electrodes disposed in the barrier rib; second discharge electrodes disposed in the barrier rib and spaced apart from the first discharge electrodes; a frit disposed between one of the pair of substrates in which the dielectric wall is not formed and the dielectric wall, and sealing the pair of substrates; a groove formed on the one of the pair of substrates in which the dielectric wall is not formed, and where at least a part of the frit is disposed; phosphor layers arranged in the discharge cells; and a discharge gas sealed in the discharge cells.

The first discharge electrodes and the second discharge electrodes may surround at least a portion of each of the discharge cells.

The first discharge electrodes may extend in a direction and the second discharge electrodes cross the first discharge electrodes.

The PDP may further comprise: third discharge electrodes crossing the first discharge electrodes and the second discharge electrodes, the first discharge electrodes and the second discharge electrodes extending in a direction.

The third discharge electrodes may be disposed in the barrier rib and spaced apart from the first discharge electrodes and the second discharge electrodes.

The third discharge electrodes may surround at least a portion of each of the discharge cells.

The grooves may be stripe-shaped.

The grooves may be spaced apart from each other and discontinuously arranged.

The frit may be disposed inside the groove.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a plan view of a conventional plasma display panel on which a frit is adhered;

FIG. 2 is a partially exploded perspective view of a plasma display panel (PDP) according to an embodiment;

FIG. 3 is a cross-sectional view of the PDP of FIG. 2 taken along a line III-III in FIG. 2, according to an embodiment;

FIG. 4 is a cross-sectional view of the PDP of FIG. 2 taken along a line IV-IV in FIG. 3, according to an embodiment;

FIG. 5 is a partially exploded perspective view of a plasma display panel (PDP) according to another embodiment;

FIG. 6 is a cross-sectional view of the PDP of FIG. 5 taken along a line VI-VI in FIG. 5, according to another embodiment; and

FIG. 7 is a cross-sectional view of the PDP of FIG. 5 taken along a line VII-VII in FIG. 6, according to another embodiment.

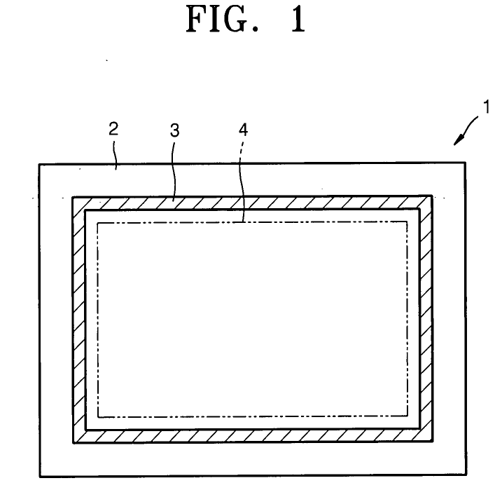

### DETAILED DESCRIPTION OF THE INVENTION

The present embodiments will now be described more fully with reference to the accompanying drawings, in which exemplary embodiments are shown.

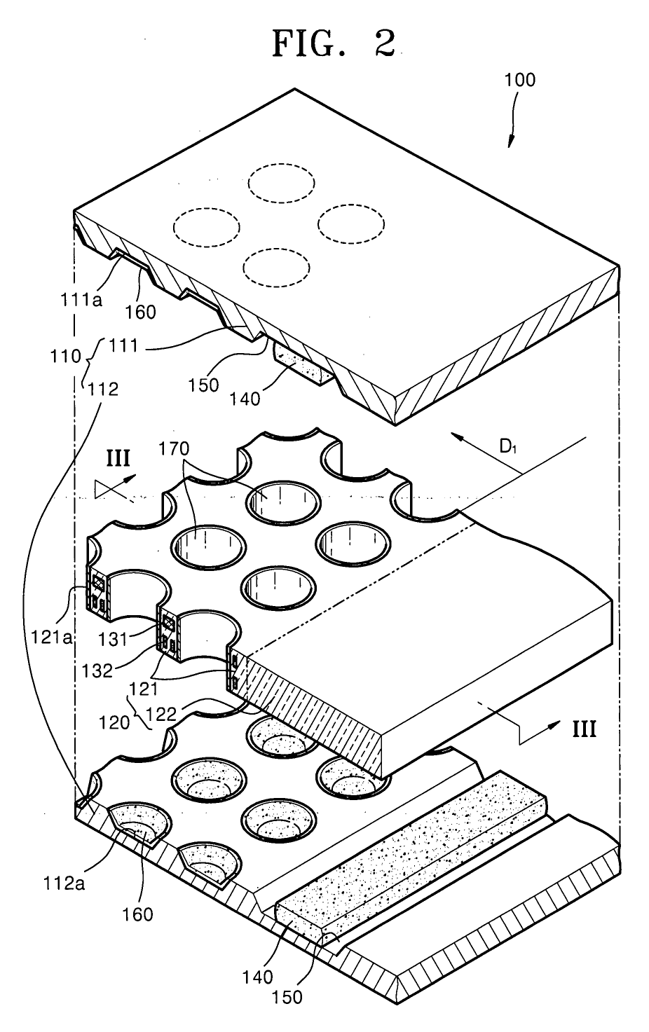

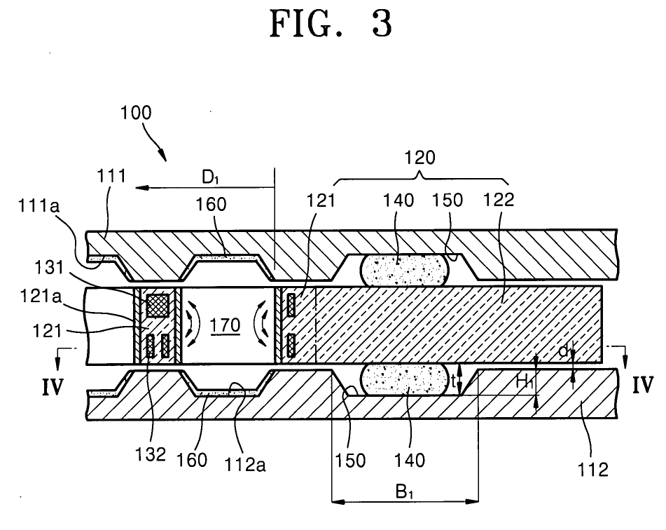

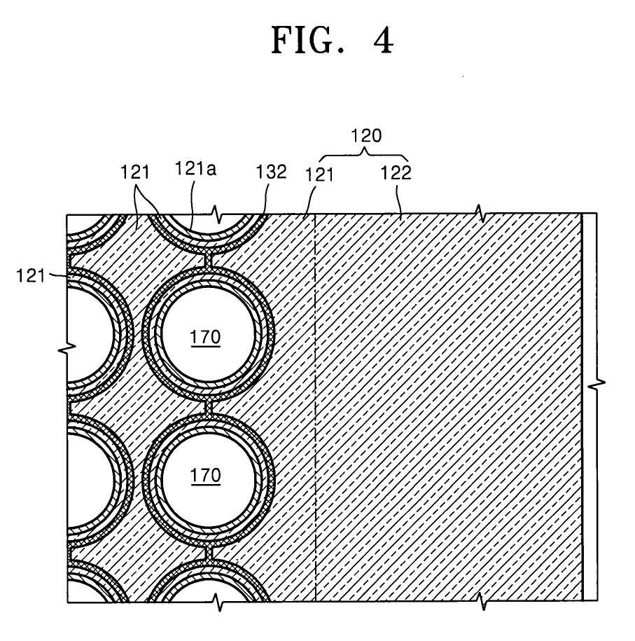

FIG. 2 is a partially exploded perspective view of a plasma display panel (PDP) 100 according to an embodiment. FIG. 3 is a cross-sectional view of the PDP of FIG. 2 taken along a line III-III in FIG. 2, according to an embodiment. FIG. 4 is a cross-sectional view of the PDP of FIG. 2 taken along a line IV-IV in FIG. 3, according to an embodiment.

Referring to FIGS. 2 and 3, the PDP 100 comprises a pair of substrates 110, first discharge electrodes 131, second discharge electrodes 132, a frit 140, grooves 150, and phosphor layers 160.

The pair of substrates 110 include a first substrate 111 and a second substrate 112 which are spaced apart from each other by a predetermined distance and face each other. The first substrate 111 is transparent and formed of material through which visible light passes, such as, for example, glass.

In the current embodiment, since the first substrate 111 is transparent, visible light generated by a discharge passes through the first substrate 111 but the present embodiments are not necessarily restricted thereto. The first substrate 111 may be formed of an opaque material whereas the second substrate 112 may be formed of a transparent material, or the first and second substrates 111 and 112 may be formed of a transparent material. Also, the first and second substrates 111 and 112 may be both formed of a translucent material and comprise a color filter.

The sheet 120 is disposed between the pair of substrates 110, and comprises a barrier rib part 121 and a dielectric part 122.

The barrier rib part 121 and the pair of substrates 110 define discharge cells 170 in which a discharge is generated, and thus, define display regions D₁ in which an image is to be displayed.

In the current embodiment, the barrier rib part 121 defines the discharge cells 170 in which the phosphor layers 160 are coated and the display regions D₁ where the image is displayed, but the present embodiments are not necessarily limited thereto. The barrier rib part 121 may partition dummy cells where the image is not displayed. Dummy cells do not include electrodes or a phosphor layers and thus do not perform a discharge. In this case, the dummy cells can be formed in the dielectric part 122 and between the discharge cells 170.

The dielectric part 122 is connected to the barrier rib part 121 and disposed on edges of the sheet 120 so that the dielectric part 122 and the frit 140 seal the pair of substrate 110.

In the current embodiment, the discharge cells 170 defined by the barrier rib part 121 have circular cross-sections, but are not necessarily restricted thereto, and can have other cross-sectional shapes such as triangular, tetragonal, octagonal, oval cross sections, etc.

The barrier rib part 121 is formed of a dielectric substance. The first discharge electrodes 131 and the second discharge electrodes 132 are buried in the barrier rib part 121.

The dielectric substance forming the barrier rib part 121 prevents conduction between the first discharge electrodes 131 and the second discharge electrodes 132 when a sustain discharge is generated, and prevents the first discharge electrodes 131 and the second discharge electrodes 132 from being damaged due to collisions between charge particles and the first discharge electrodes 131 and the second discharge electrodes 132, thereby accumulating wall charges by inducing the charge particles. The dielectric substance may be, for example, PbO, B₂O₃, SiO₂, etc.

In the current embodiment, a dielectric substance forming the dielectric part 122 is the same as that of the barrier rib part 121, but the present embodiments are not necessarily restricted thereto. The dielectric substance forming the dielectric part 122 may be different form that of the barrier rib part 121. In this case, since a discharge is not generated in the electric part 122, a dielectric constant is adjusted to properly select the dielectric substance.

Protective layers 121a cover sides of the barrier rib part 121 that surround each of the discharge cells 170. The protection layers 121a that may be formed of, for example, magnesium oxide (MgO) prevent the first discharge electrodes 131 and the second discharge electrodes 132 and the barrier rib part 121 formed of the dielectric substance from being damaged due to sputtering of plasma particles, discharge secondary electrons, and reduce a discharge voltage.

The second discharge electrodes 132 are spaced-apart from the first discharge electrodes 131, and cross the first discharge electrodes 131.

In the current embodiment, the first discharge electrodes 131 perform an addressing function since the first discharge electrodes 131 and the second discharge electrodes 132 cross each other but the present embodiments are not necessarily restricted thereto. The PDP of the present embodiments comprises electrodes that perform the addressing function, that is, the PDP of the present embodiments is a 3D type PDP.

In the present embodiment, the first discharge electrodes 131 and the second discharge electrodes 132 surround each of the discharge cells 170. Referring to FIG. 4, the second discharge electrodes 132 are in the shape of a ring. Although the cross-sections of the second discharge electrodes 132 are not shown, the first discharge electrodes 131 are also in the shape of the ring in this embodiment.

In the current embodiment, the first discharge electrodes 131 and the second discharge electrodes 132 are in the shape of the ring but are not necessarily restricted thereto. The first discharge electrodes 131 and the second discharge electrodes 132 that surround each of the discharge cells 170 can be in the shape of a ladder, an oval ring, a polygon, etc.

In the present embodiment, the first discharge electrodes 131 and the second discharge electrodes 132 surround each of the discharge cells 170 so that a sustain discharge is generated in a perpendicular direction at every perimeter position defining the discharge cells 170, but are not necessarily restricted thereto. The first and second discharge electrodes 131 and 132 may be stripe-shaped and buried in the barrier rib part 121. In this case, the first and second discharge electrodes 131 and 132 have a discharge path of an opposite discharge than that of a surface discharge. Also, the first and second discharge electrodes 131 and 132 have various structures such as a partially disconnected ring structure. In the case, the first and second discharge electrodes 131 and 132 can surround a portion of each of the discharge cells 170.

In the present embodiment, since the first discharge electrodes 131 and the second discharge electrodes 132 are arranged inside the sheet 120, the first discharge electrodes 131 and the second discharge electrodes 132 are not transparent electrodes, and can be formed of a conductive and anti-resistant metal such as Ag, Al, etc., such that the PDP 100 can quickly respond to a discharge, does not distort a signal, and requires less power consumption for the sustain discharge.

The frit 140 is adhered between the dielectric part 122 of the sheet 120 and the pair of substrates 111 and 112 to seal the pair of substrates 111 and 112.

The grooves 150 are formed in the first and second substrates 111 and 112 where the frit 140 is to be adhered and continuously arranged in the shape of a stripe.

The grooves 150 face the sheet 120 oppose each other. A virtual surface which crosses one of the grooves 150 and is perpendicular to the sheet 120 crosses another groove 150 so that the grooves 150 are aligned to each other.

In the current embodiment, the grooves 150 face the sheet 120 and oppose each other but the present embodiments are not restricted thereto. Since the balance is well maintained during a process of sealing the pair of substrates 111 and 112, as long as the sealing processes is successful, the grooves 150 do not oppose each other.

The grooves 150 prevent the frit 140 from entering into the barrier rib part 121 during the sealing process. When the frit 140 is pressurized through the sealing process and spreads along the grooves 150, the grooves 150 have sufficient width B₁ and depth H₁ (See FIG. 3), thereby preventing the frit 140 from moving to the barrier rib part 121. Therefore, the width B₁ and depth H₁ of the grooves 150 are determined based on an amount of the frit 140 to be adhered.

If the grooves 150 are not formed in the PDP 100, the frit 140 more widely spreads than that shown in FIG. 3, in a way that the frit 140 can move to the barrier rib part 121, thereby contaminating the discharge cells 170 with the frit 140.

In the current embodiment, the grooves 150 are continuously arranged in the shape of the stripe along the frit 140 to be adhered but the present embodiments are not restricted thereto. The grooves 150 can be spaced apart from each other and discontinuously arranged.

The phosphor layers 160 are adhered to recess parts 111a and 112a formed on the first substrate 111 and the second substrate 112 defining the discharge cells 170 that may comprise red, green, and blue discharge cells 170. The recess parts 111a and 112a are formed on the first substrate 111 and the second substrate 112 where the discharge cells 170 are disposed using sand blasting, etching, laser etching, etc.

The phosphor layers 160 have a component generating visible light with ultraviolet rays. That is, a phosphor layer formed in a red light emitting discharge cell has a phosphor such as Y(V,P)O₄:Eu, a phosphor layer formed in a green light emitting discharge cell has a phosphor such as Zn₂SiO₄:Mn, YBO₃:Tb, and a phosphor layer formed in a blue light emitting discharge cell has a phosphor such as BAM:Eu.

The phosphor layers 160 of the present embodiment are formed on the recess parts 111a and 112a, to which a phosphor substance is adhered, on the first substrate 111 and the second substrate 112 but the present embodiments are not necessarily restricted thereto. The phosphor layers 160 can be formed in any portions of the discharge cells 170 such as sides of the barrier rib part 121, in order to discharge visible light using ultra violet rays generated by a plasma discharge.

After the PDP 100 is sealed, a discharge gas such as Ne, Xe, or a mixture thereof is filled in the PDP 100.

A manufacturing method and functions of the PDP 100 according to the present embodiment will now be described in detail.

The manufacturing operations of the PDP 100 comprise forming the sheet 120, forming the recess parts 111a and 112a of the pair of the substrates 110 and the grooves 150, forming the phosphor layers 160, assembling and sealing the PDP 100, and injecting the discharge gas.

A method of forming the sheet 120 will now be described.

The first discharge electrodes 131 and the second discharge electrodes 132 are buried, dieelectric sheets are stacked, and punches in which the discharge cells 170 are to be formed are formed in the sheet 120 to form the barrier rib part 121.

The protective layers 121a formed of, for example, MgO are disposed on surfaces of the barrier rib part 121 using vacuum deposition.

The phosphor layers 160 are formed on the pair of substrates 110 by etching portions where the discharge cells 170 are formed using glass cutting methods such as sand blasting, etching, laser etching, etc., forming the recess parts 111a and 112a, and adhering a phosphor substance to the recess parts 111a and 112a.

The grooves 150 are formed in edges of the portions where the discharge cells 170 are formed on the pair of substrates 110 using sand blasting, etching, etc.

The sheet 120 is inserted into the pair of substrates 110 by continuously adhering the frit 140 in the center of the grooves 150 in order to prevent the frit 140 from moving out of the grooves 150, and sealing the first substrate 111 and the second substrate 112.

Both sides of the pair of substrates 110 are heated and pressurized to spread the frit 140 along spaces between the grooves 150 and the dielectric part 122, so that the frit 140 fills the grooves 150 and is restricted in its movement, thereby preventing the frit 140 from entering into the barrier rib part 121.

Once the PDP 100 is completely sealed, a vacuum exhaust process of the PDP 100 is performed, and the discharge gas is injected into the PDP 100.

The operation of the PDP 100 will now be described in detail.

After the manufacturing of the PDP 100 and the injection of the discharge gas are complete, if an address voltage is applied between the first discharge electrodes 131 and the second discharge electrodes 132 from an external power source, an address discharge is generated. Thus, a discharge cell where a sustain discharge is to be generated is selected from the discharge cells 170.

If a discharge sustain voltage is applied between first discharge electrodes 131 and the second discharge electrodes 132 of the selected discharge cell 170, the sustain discharge is generated due to movement of wall charges accumulated in the barrier rib part 121 by the first discharge electrodes 131 and the second discharge electrodes 132. The energy level of the discharge gas excited by the sustain discharge is reduced, thereby discharging ultraviolet rays.

The ultraviolet rays excite the phosphor layers 160 in the discharge cells 170. The energy level of the excited phosphor layers 160 is reduced to emit visible light. The emitted visible light passes through the first substrate 111 and forms an image to be recognized by a user.

In the current embodiment, the frit 140 does not penetrate into the display regions D₁ due to the grooves 150 formed on the pair of substrates 110, which prevents spots of the image to be displayed, thereby improving quality of the image.

The PDP 100 of the current embodiment forms the grooves 150 on the pair of substrates 110, which prevents the frit 140 from extensive spreading, thereby preventing the frit 140 from entering into the barrier rib part 121. Therefore, spots of the image to be displayed are prevented, thereby improving quality of the image and reducing manufacturing costs.

Also, the PDP 100 of the current embodiment can reduce the size d of a different level caused by the thickness t of the frit 140, thereby preventing the sheet 12 from being broken due to a force applied by a sealing clip.

Also, the first discharge electrodes 131 and the second discharge electrodes 132 surround each of the discharge cells 170 so that the sustain discharge is performed at every perimeter position of the discharge cells 170. Therefore, the PDP 100 of the present embodiment has a relatively wide discharge area, thereby increasing light-emitting brightness and light emitting efficiency.

Also, the PDP 100 of the current embodiment comprises the sheet 120 so that it is not necessary to stack a barrier rib on substrates to form the discharge cells 170. In the current embodiment, circular punches are formed in spaces where the sheet 120 is formed and the discharge is performed to form the discharge cells 170, thereby simplifying the manufacturing process and reducing manufacturing costs.

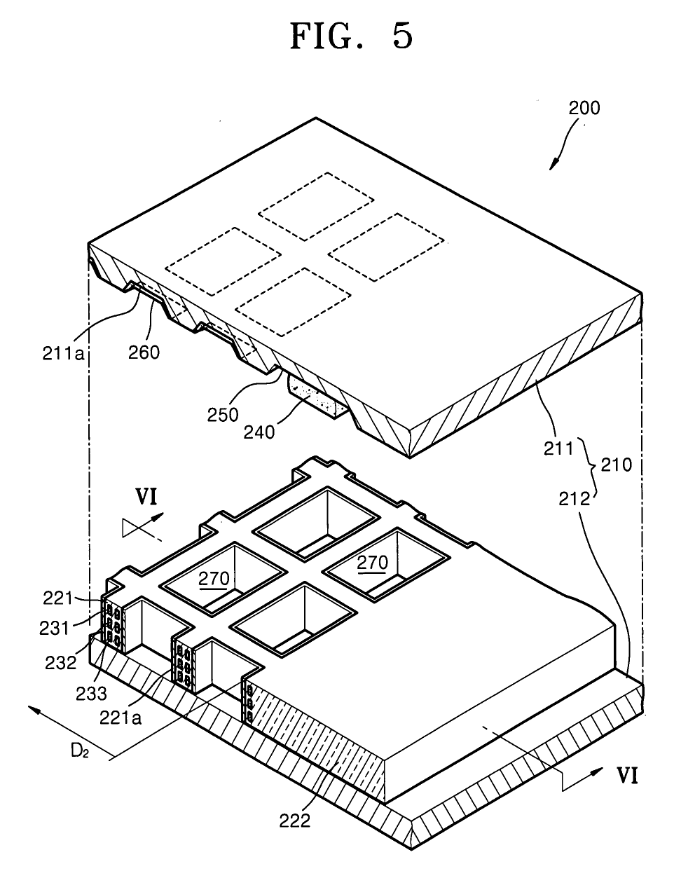

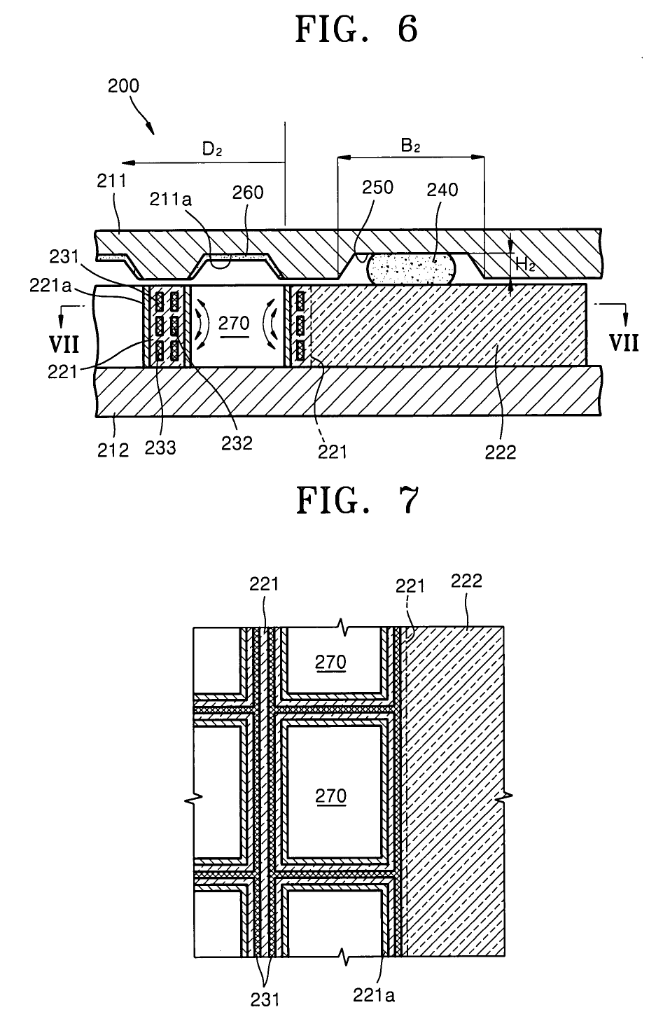

FIG. 5 is a partially exploded perspective view of a plasma display panel (PDP) 200 according to another embodiment. FIG. 6 is a cross-sectional view of the PDP of FIG. 5 taken along a line VI-VI in FIG. 5, according to another embodiment. FIG. 7 is a cross-sectional view of the PDP of FIG. 5 taken along a line VII-VII in FIG. 6, according to another embodiment.

Referring to FIGS. 5 and 6, the PDP 200 comprises a pair of substrates 210, a barrier rib 221, a dielectric wall 222, first discharge electrodes 231, second discharge electrodes 232, third discharge electrodes 233, a frit 240, a groove 250, and phosphor layers 260.

The pair of substrates 210 include a first substrate 211 and a second substrate 212 which are spaced apart from each other by a predetermined distance and face each other. The first substrate 211 is transparent and formed of glass through which visible light passes.

The barrier rib 221 which is disposed between the pair of substrate 210 and the pair of substrates 210 define discharge cells 270 in which a discharge is generated, and thus, degine display regions D₂ in which an image is to be displayed.

In the current embodiment, the barrier rib 221 defines the discharge cells 270 in which the phosphor layers 260 are coated and the display regions D₂ where the image is displayed, but the present embodiments are not necessarily limited thereto. The barrier rib 221 may partition dummy cells where the image is not displayed.

The discharge cells 270 defined by the barrier rib 221 have tetragonal cross-sections.

The dielectric wall 222 is disposed in an edge of the barrier rib 221 that is an edge portion of the PDP 200.

The dielectric wall 222 is stacked on the second substrate 212 but the present embodiments are not necessarily limited thereto. Since the dielectric wall 222 of the present embodiments can be formed on any one of the pair of substrates 210, the dielectric wall 22 can be formed on the first substrate 211.

The dielectric wall 222 and the frit 240 seal the pair of substrates 210.

The barrier rib 221 is formed of a dielectric substance. The first discharge electrodes 231, the second discharge electrodes 232, and the third discharge electrodes 233 are buried in the dielectric substance.

The dielectric substance forming the barrier rib 221 prevents conduction between the first discharge electrodes 231, the second discharge electrodes 232, and the third discharge electrodes 233 when a sustain discharge is generated, and prevents the first discharge electrodes 231, the second discharge electrodes 232, and the third discharge electrodes 233 from being damaged due to collisions between charge particles and the first discharge electrodes 231, the second discharge electrodes 232, and the third discharge electrodes 233, thereby accumulating wall charges by inducing the charge particles. The dielectric substance may be, for example, PbO, B₂O₃, SiO₂, etc.

A protective layer 221 a covers sides of the barrier rib 221 and is formed of, for example, magnesium oxide (MgO).

The second discharge electrodes 232 are spaced apart from the first discharge electrodes 231. The third discharge electrodes 233 are spaced apart from the second discharge electrodes 232. The first and second discharge electrodes 231 and 232 extend in a direction. The third discharge electrodes 233 cross the first and second discharge electrodes 231 and 232 and serve as address electrodes that perform an addressing function.

The arrangement structure of the first discharge electrodes 231, the second discharge electrodes 232, and the third discharge electrodes 233 of the current embodiment of the present embodiments are not limited thereto. Two discharge electrodes among the first discharge electrodes 231, the second discharge electrodes 232, and the third discharge electrodes 233 are arranged in a direction, and other discharge electrodes are arranged to cross the two discharge electrodes. In this case, ones of the two discharge electrodes serve as scan electrodes, the others of the two discharge electrodes serve as common electrodes, and the others serve as address electrodes.

The first discharge electrodes 231, the second discharge electrodes 232, and the third discharge electrodes 233 surround each of the discharge cells 270. The first discharge electrodes 231 are in the shape of a ladder with reference to FIG. 7.

Although not shown, the second discharge electrodes 232 and the third discharge electrodes 233 are in the shape of the ladder in this embodiment.

In the present embodiment, first discharge electrodes 231, the second discharge electrodes 232, and the third discharge electrodes 233 surround each of the discharge cells 270, but are not necessarily restricted thereto. The first discharge electrodes 231, the second discharge electrodes 232, and the third discharge electrodes 233 surround each of the discharge cells 270 may be stripe-shaped. In this case, the first discharge electrodes 231, the second discharge electrodes 232, and the third discharge electrodes 233 have a discharge path of an opposite discharge rather than a surface discharge. The first discharge electrodes 231, the second discharge electrodes 232, and the third discharge electrodes 233 can surround a portion of each of the discharge cells 270.

In the present embodiment, since first discharge electrodes 231, the second discharge electrodes 232, and the third discharge electrodes 233 are arranged inside the barrier rib 221, the first discharge electrodes 231, the second discharge electrodes 232, and the third discharge electrodes 233 cannot be transparent electrodes, and can be formed of a conductive and anti-resistant metal such as, for example, Ag, Al, etc.

The frit 240 is adhered between the dielectric wall 222 and the groove 250 of the first substrate 211 to seal the pair of substrates 211 and 212.

The groove 250 is formed in the first substrate 211 where the frit 240 is to be adhered and continuously arranged in the shape of a stripe.

The groove 250 prevents the frit 240 from entering into the barrier rib 221 during the sealing process. When the frit 240 is pressurized through the sealing process and spreads along the groove 250, the groove 250 has sufficient width B₂ and depth H₂, thereby preventing the frit 240 from moving to the barrier rib 221.

Therefore, the width B₂ and depth H₂ of the groove 250 is determined based on an amount of the frit 240 to be adhered.

In the current embodiment, the groove 250 is continuously arranged in the shape of the stripe along the frit 240 to be adhered but the present embodiments are not necessarily restricted thereto. The groove 250 can be spaced apart from each other and discontinuously arranged.

The phosphor layers 260 are adhered to recess parts 211a formed on the first substrate 211 in accordance with the red, green, and blue discharge cells 270. The recess parts 211a are formed on the first substrate 211 where the discharge cells 270 are disposed using sand blasting, etching, laser etching, etc. Phosphor components are the same as the phosphor layers 160 of the previous embodiment and thus their descriptions are omitted.

After the pair of the substrates 210 is sealed, a discharge gas such as Ne, Xe, or a mixture thereof is filled in the PDP 200.

The manufacturing method and functions of the PDP 200 according to the present embodiment will now be described in detail.

The manufacturing operations of the PDP 200 comprise forming the barrier rib 21 and the dielectric layer 222 on the second substrate 212, forming the recess parts 211a, the phosphor layers 260, and the groove 250 on the first substrate 211, assembling and sealing the PDP 200, and injecting the discharge gas.

A method of forming the barrier rib 221 and the dielectric layer 222 on the second substrate 212 will now be described.

The barrier rib 221 is formed by stacking dielectric substances on the second substrate 212 and sequentially burying the third discharge electrodes 233, the second discharge electrodes 232, and the first discharge electrodes 231 using sand blasting, screen printing, etc.

The dielectric wall 222 is formed by stacking dielectric substances on the second substrate 212. The dielectric wall 222 is integrally formed with the formation of the barrier rib 221 using sand blasting, screen printing, etc.

In the current embodiment, the barrier rib 221 and the dielectric wall 222 are simultaneously formed but the present embodiments are not limited thereto. The barrier rib 221 and the dielectric wall 222 of the current embodiment can be formed at a different time.

The barrier rib 221 and the dielectric wall 222 of the current embodiment contact each other but the present embodiments are not limited thereto. The barrier rib 221 and the dielectric wall 222 of the current embodiment can be spaced apart from each other by a predetermined gap.

A protective layer 221a formed of MgO, for example, is disposed on surfaces of the barrier rib 221 using vacuum deposition.

The phosphor layers 260 are formed on the first substrate 211 by etching portions where the discharge cells 270 are formed using sand blasting, etching, laser etching, etc., forming the recess parts 211a, and adhering a phosphor substance to the recess parts 211a.

The groove 250 is formed in the shape of the stripe on the first substrate 211 using sand blasting, etching, etc. A designer properly determines where the groove 250 is formed based on the width of the dielectric wall 222 and an amount of the frit 240 to be adhered, etc.

Thereafter, the first substrate 211 and the second substrate 212 are assembled. During the assembling, the frit 240 is adhered to the center of the groove 250 in order to prevent the frit 240 from moving out of the groove 250. Then the first substrate 211 and the second substrate 212 are sealed.

Both sides of the pair of substrates 210 are heated and pressurized to spread the frit 240 along spaces between the groove 250 of the first substrate 211 and the dielectric wall 222, so that the frit 240 fills the groove 250 and is restricted in its movement, thereby preventing the frit 240 from entering into the barrier rib 221.

Once the PDP 200 is completely sealed, a vacuum exhaust process of the PDP 200 is performed, and the discharge gas is injected into the PDP 200.

The operation of the PDP 200 will now be described in detail.

After the manufacturing of the PDP 200 and the injection of the discharge gas are complete, if an address voltage is applied between the first discharge electrodes 231 or the second discharge electrodes 232 that serve as the scan electrodes and the third discharge electrodes 233 from an external power source, an address discharge is generated. Thus, a discharge cell where a sustain discharge is to be generated is selected from the discharge cells 270.

If a discharge sustain voltage is applied between first discharge electrodes 231 and the second discharge electrodes 232 of the selected discharge cell 270, the sustain discharge is generated due to movement of wall charges accumulated in the barrier rib 221 by the first discharge electrodes 231 and the second discharge electrodes 232. The energy level of the discharge gas excited by the sustain discharge is reduced, thereby discharging ultraviolet rays.

The ultraviolet rays excite the phosphor layers 260 in the discharge cells 270. The energy level of the excited phosphor layers 260 is reduced to emit visible light. The emitted visible light passes through the first substrate 211 and forms an image to be recognized by a user. In the current embodiment, the frit 240 does not penetrate into the display regions D₂ due to the groove 250, which prevents spots of the image to be displayed, thereby improving quality of the image.

The PDP 200 of the current embodiment forms the groove 250 on the first substrate 221, thereby preventing the frit 240 from entering into the barrier rib 221. Therefore, spots of the image to be displayed are prevented, thereby improving quality of the image and reducing manufacturing costs.

Also, the first discharge electrodes 231, the second discharge electrodes 232, and the third discharge electrodes 233 surround each of the discharge cells 270 so that the sustain discharge is performed at every perimeter position of the discharge cells 270. Therefore, the PDP 200 of the present embodiment has a relatively wide discharge area, thereby increasing light-emitting brightness and light emitting efficiency.

As described above, the PDP according to the present embodiments forms a groove on at least one of a pair of substrates and prevents a frit from penetrating into display regions. Therefore, spots of an image to be displayed by the PDP are prevented, thereby improving quality of the image, reducing a percent defective, and reducing manufacturing costs.

The PDP of the present embodiments has a relatively wide discharge area since discharge electrodes are buried in a sheet or a barrier rib to surround each of discharge cells, thereby increasing light-emitting brightness and light emitting efficiency.

The PDP of the present embodiments can be formed by manufacturing a sheet, forming discharge spaces on the sheet, and disposing the sheet having the discharge spaces between a pair of substrates, thereby simplifying manufacturing processes and reducing manufacturing costs.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel (PDP) comprising:
a pair of substrates spaced apart from each other and facing each other;
a sheet interposed between the pair of substrates, the sheet comprising a barrier rib part defining discharge cells and a dielectric part disposed on edges of the barrier rib part;
first discharge electrodes disposed in the sheet;
second discharge electrodes disposed in the sheet and spaced apart from the first discharge electrodes;
a frit disposed between the pair of substrates and the dielectric part and sealing the pair of substrates;
a groove formed on at least one of the pair of substrates, wherein at least a part of the frit is disposed in the grove;
phosphor layers arranged in the discharge cells; and
a discharge gas sealed in the discharge cells.

2. The PDP of claim 1, wherein the first discharge electrodes and the second discharge electrodes surround at least a portion of each of the discharge cells.

3. The PDP of claim 1, wherein the first discharge electrodes extend in a direction and the second discharge electrodes cross the first discharge electrodes.

4. The PDP of claim 1, further comprising: third discharge electrodes crossing the first discharge electrodes and the second discharge electrodes.

5. The PDP of claim 4, wherein the third discharge electrodes are disposed in the sheet and are spaced apart from the first discharge electrodes and the second discharge electrodes.

6. The PDP of claim 5, wherein the third discharge electrodes surround at least a portion of each of the discharge cells.

7. The PDP of claim 1, wherein the grooves are stripe-shaped.

8. The PDP of claim 1, wherein the grooves are spaced apart from each other and discontinuously arranged.

9. The PDP of claim 1, wherein, when the grooves are formed in each of the pair of substrates, and wherein the grooves face the sheet and oppose each other.

10. The PDP of claim 1, wherein the frit is disposed inside the grooves.

11. A plasma display panel (PDP) comprising:
a pair of substrates spaced apart from each other and facing each other;
a barrier rib interposed between the pair of substrates and, and defining discharge cells;
a dielectric wall formed on at least one of the pair of substrates and disposed on edges of the barrier rib;
first discharge electrodes disposed in the barrier rib;
second discharge electrodes disposed in the barrier rib and spaced apart from the first discharge electrodes;
a frit disposed between one of the pair of substrates in which the dielectric wall is not formed and the dielectric wall, wherein the frit seals the pair of substrates;
a groove formed on the one of the pair of substrates in which the dielectric wall is not formed, wherein at least a part of the frit is disposed in the groove;
phosphor layers arranged in the discharge cells; and
a discharge gas sealed in the discharge cells.

12. The PDP of claim 11, wherein the first discharge electrodes and the second discharge electrodes surround at least a portion of each of the discharge cells.

13. The PDP of claim 11, wherein the first discharge electrodes extend in a direction and the second discharge electrodes cross the first discharge electrodes.

14. The PDP of claim 11, further comprising: third discharge electrodes crossing the first discharge electrodes and the second discharge electrodes.

15. The PDP of claim 14, wherein the third discharge electrodes are disposed in the barrier rib and are spaced apart from the first discharge electrodes and the second discharge electrodes.

16. The PDP of claim 15, wherein the third discharge electrodes surround at least a portion of each of the discharge cells.

17. The PDP of claim 11, wherein the grooves are stripe-shaped.

18. The PDP of claim 11, wherein the grooves are spaced apart from each other and discontinuously arranged.

19. The PDP of claim 11, wherein the frit is disposed inside the groove.
